(19) United States
(12) Patent Application Publication
(10) Pub. No.: US 2004/0069065 A1
(43) Pub. Date: Apr. 15, 2004

(54) System and method for determining particle size in particulate solids

(76) Inventors: Stephen Tallon, Lower Hutt (NZ); Clive Eric Davies, Waikanae (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/416,401

(22) PCT Filed: Nov. 13, 2001
(86) PCT No.: PCT/NZ01/00253

(30) Foreign Application Priority Data
Nov. 13, 2000 (NZ) 508127

(51) Int. Cl. G01N 15/02; G01N 29/18; G01N 9/06; G01N 29/02

(52) U.S. Cl. 73/597; 73/434; 702/100

(57) ABSTRACT

A method for assessing the particle size of a bulk particulate material (1), such as powdered or granular material includes transmitting sound energy (as herein defined) through the particulate material (1) from a source (2) to a detector (3), and assessing the particle size from the time taken to pass through the material from the source (2) to detector (3) or signal velocity, through the material (1). Typically the signal is a frequency or frequencies in the range about 20 Hz to 20 kHz (but higher frequencies are envisaged), and the particulate material may be in a moving production stream of the particulate material (1). Apparatus is also claimed.

### FIELD OF INVENTION

The present invention relates to a method and apparatus for assessing the size of particles in dry bulk particulate solids.

### BACKGROUND OF INVENTION

The flow behaviour and many of the bulk properties of particulate products are often strongly influenced by the size of the particles, and in many particle processing operations particle size may be one of the key control variables or one of the major quality specifications of the product. There is thus a need for reliable and rapid methods for measuring or assessing particle size in flows of dry particulate material but there are few potential in-line, or even on-line, options available. Malvern Instruments Ltd sell an instrument for real time particle size analysis of dry powders which uses laser diffraction or more particularly low angle laser light scattering (www.malvern.co.uk).

Particle size measurement using ultrasonics has been applied to liquid-solid systems comprising solid particles in a liquid suspension—see U.S. Pat. No. 5,569,844 for example. However such techniques suitable for liquid-solid systems are more complex, and may not be applicable to dry bulk particulate materials such as powdered or granular materials, whether static or flowing. SUMMARY OF THE INVENTION

The invention provides a simple method for assessing particle size in dry bulk particulate materials such as powdered and granular materials.

In broad terms in one aspect the invention comprises a method for assessing the particle size of a bulk particulate material, including: transmitting sound energy through the particulate material from a source to a detector, and assessing the particle size from the the time taken for said energy to pass through the material from the source to detector or signal velocity, through the material.

Preferably the sound energy is a frequency or frequencies in the range about 20 Hz to 20 k Hz, and typically up to about to 10 k Hz. Typically the mean diameter of the particulate material will be less than about 6000 microns.

Where the material is moving during transmission and detection the method preferably includes causing the material to flow through a measuring cell positioned within the material flow and which tends to bulk the material and the signal source and the detector are arranged to transmit and detect the sound energy through material in the measuring cell.

The method may also include assessing the bulk density of the material in the measuring cell. Information on the bulk density of the material may be combined with information on the particle size of the material to improve the accuracy of the assessment of particle size.

In broad terms in another aspect the invention comprises apparatus for assessing the size of particles of a bulk particulate material including a signal source arranged to transmit sound energy through the material, a detector arranged to detect the transmitted energy, and means arranged to assess particle size from the time taken for the signal to travel from the source to the detector or the signal velocity, through the material.

Preferably the apparatus includes a measuring cell arranged to be positioned within the material flow and which tends to bulk the material and the signal source and the detector are arranged to transmit and detect the sound energy through material in the measuring cell.

Preferably the apparatus also includes a density measurement stage for also assessing the bulk density of the particulate material, and optionally processing means arranged to combine information on the bulk density of the material with information on the particle size of the material to improve the accuracy of the assessment of particle size. One preferred form of density measurement stage includes a weighing cell having an inlet through which the particulate material may flow into the weighing cell to maintain a constant volume of flowing material in the weighing cell and an outlet for exit of the flowing material from the weighing cell, means associated with the weighing cell for continuously or semi-continuously providing an indication of the weight of the contents of the cell, and means for continuously or semi-continuously determining the bulk density of the material passing through the weighing cell by reference to the weight indication thereof. The density measurement stage may also include a feed cell which supplies flowing material to the weighing cell.

We have found that particle size in dry bulk particulate material such as powdered or granular material, in static condition or in bulk flow, can be assessed by reference to acoustic velocity through the material. When the period of the acoustic wave is sufficiently long the particles have sufficient time to respond physically to variations in the gas phase properties, and the solid particles will then to vibrate in phase with the gas particles. The propagation velocity is low. When the wave period is much shorter, the particles can no longer keep up with the gas phase variations, and the particles can be considered to be effectively fixed in space with the wave propagating through the continuous gas phase around them. The propagation velocity in this case approaches that of, or near to that of, the single phase gas propagation velocity. We have found that for a frequency or frequencies that span this transitional region, the measured propagation velocity depends strongly on the particle size, and that for particle sizes typically ranging from 65 μm to 6000 μm, the transition occurs predominantly in the sound frequency range (as defined below).

### BRIEF DESCRIPTION OF DRAWINGS

Preferred forms of the method and apparatus of the invention are further illustrated by the accompanying drawings, by way of example and without intending to be limiting, wherein:

FIG. 1 is a schematic diagram of an apparatus of the invention for use with a descending material flow in a downcomer or similar,

FIG. 2 is a schematic diagram of another apparatus of the invention for use with a descending material flow,

FIG. 3 is a schematic diagram of another apparatus of the invention for use with a descending material flow,

FIGS. 4A and 4B are schematic diagrams of apparatus of the invention for use with a material flow in a chute or otherwise on a sloping surface,

FIGS. 5A and 5B are schematic diagrams of another apparatus of the invention for use with a material flow in a chute or on a sloping surface,

FIGS. 6A and 6B are schematic diagrams of another apparatus of the invention for use with a material flow in a chute or otherwise on a sloping surface,

FIGS. 7A and 7B are schematic diagrams showing application of apparatus of the invention to material in a rotating mixer or bin blender,

FIGS. 8A and 8B are schematic diagrams of application of the invention to material passing through a drum granulator,

FIG. 9 is a graph showing acoustic velocity as a function of frequency for different materials measured using the method of the invention,

FIG. 10 is a graph showing acoustic velocity at 400 Hz and 900 Hz as a function of surface mean particle size for different materials,

FIG. 11 is a graph showing the acoustic velocity through flowing sand with transitions in surface mean particle size, and

FIG. 12 is a schematic diagram of a density measurement stage which may be combined with a particle size assessment stage of the invention,

### DESCRIPTION OF PREFERRED FORMS

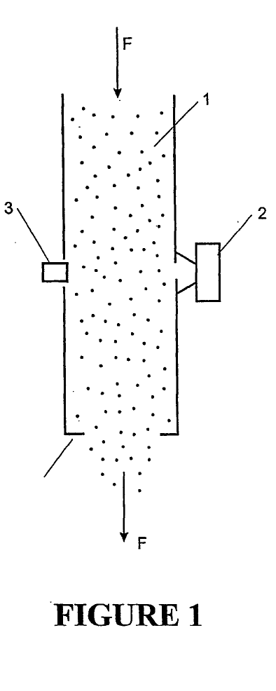

FIG. 1 shows one arrangement of apparatus for assessing particle size of powdered or granular material in bulk flow descending in a downcomer or similar. Material in a product stream flows through a conduit 1 in the direction of arrows F and is constrained by orifice 6 or the like such that there will be a continuous flow of dense bulk material upstream of the orifice 6, between a transmitter 2 and a detector 3. Conduit 1 may be a pipe through which a product stream of the material descends, or alternatively may comprise a short measuring cell which in turn is positioned within a larger diameter conduit which carries the material flow, or which otherwise is positioned within the product stream, so that a sample of the material flow is continuously caught in the measuring cell 1 while the part of the product stream not caught in the measuring cell 1 flows around the sides of the measuring cell 1 and excess material spilling from the top of the measuring cell 1 spills back into and continues in the product flow.

Driving energy to transmitter 2 is generated from a suitable source (and amplifier). For example the transmitter may be a speaker attached to the outside wall of conduit 1 with a small hole through to the interior which is suitably covered with a fine mesh to contain the solids but allow the sound energy to enter the bed of solids. Alternatively for example a thin walled section of the conduit wall may form the transmitter diaphragm. The transmitter 2 may be of any suitable form. The front face of microphone or detector 3 may also be covered with fine mesh so that it's sensing surface is not in direct contact with the solids, and only gas phase pressure variations passing through the bull particulate material are recorded. Energy from transmitter 2 is detected by detector 3, and particle size is assessed relative to the velocity of the signal through the material from source to detector. In the diagram the transmitter 2 and detector 3 are shown on opposite sides of the flow but the transmitter and detector could alternatively be maintained on the same side of the conduit 1 or measuring cell.

Preferably the signal to the transmitter 2 is in the range 50 Hz to 10 kHz. We have found that this is the frequency range within which propagation velocity depends strongly on particle size in bulk dry particulate materials. However frequencies in the range 20 Hz to 20 kHz, or up to 50 kHz may still give differentiation between different particles sizes, and in this specification and claims “sound energy” should be understood accordingly, as including audible and also ultrasound frequencies, up to about 50 k Hz. In general smaller particle sizes will require higher frequencies. However the limit of effectiveness is likely to be approached at the higher frequencies and higher attenuation of the transmitted energy in the particulate material occurs at higher frequencies also.

The driving energy may be transmitted as pulses or bursts of energy of a similar frequency or which sweep over a frequency band. Alternatively the driving frequency may be transmitted continuously and the phase relationship between the detected and transmitted signal analysed to obtain information indicative of transmission time or sound velocity. The signal may have a sound pressure amplitude varying between about 200 Pa and 800 Pa depending on frequency, for example.

The transmitted signals are preferably digitised, for example at 1000 kHz for acoustic frequencies above 500 Hz and at 200 kHz for acoustic frequencies below 600 Hz. Typically the input signal to the transmitter 2 may be cross-correlated with the recorded signal from the detector to determine the time delay between transmitted and detected signal. The transmission time or velocity has been found to be indicative of the mean diameter of the particles.

The measuring cell 1 may provide a continuous output signal to for example a microprocessor arranged to determine particle size via an algorithm, by reference to look-up tables, or by further calculations, which through calibration information may also be contained in the look-up tables or the like. The particle size information may be passed to a computerised control system of a production stream or may be stored, displayed through a suitable visual display, graphed by a plotter or the like, for example. The particle size indication from the apparatus could be arranged to be a running mean particle size, for example.

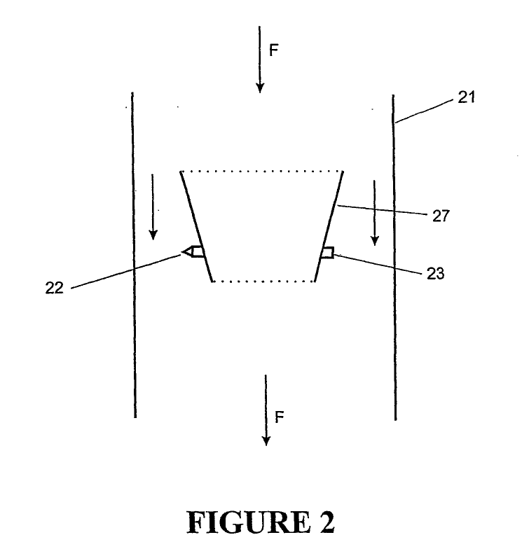

FIG. 2 shows another arrangement of apparatus for assessing particle size in a descending material flow. Material flows through conduit 21 in the direction of arrows F. Some material passes through and is continuously delayed by conical inverted frustro-conical measuring cell 27 so that the cell 27 is continuously filled with flowing but bulked material, while other material flows around the sides of the measuring cell. Measuring cell 27 may be in any shape or form which typically has a smaller exit than entry to achieve some bulking of the flowing particulate material. For example in another form measuring cell 27 may be formed by only two plates arranged on either side of the flow and angled towards each other in the flow direction, so that material passing between the plates experiences a degree of bulking. Energy from transmitter 22 is received by detector 23.

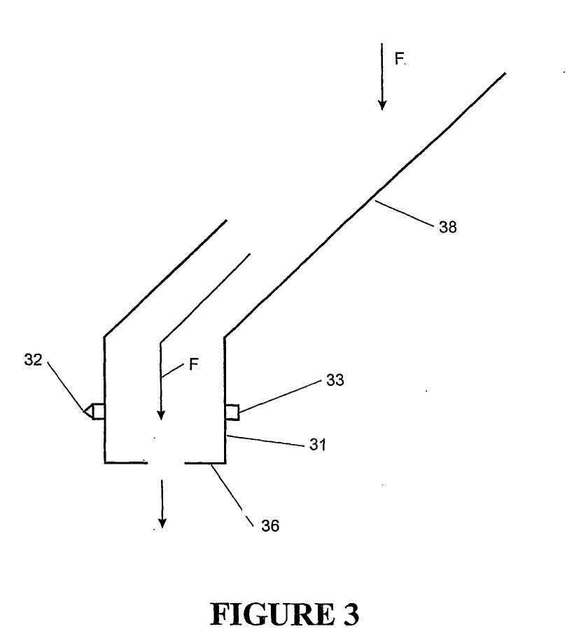

In FIG. 3 material flows into measuring cell 31 which may be positioned within a flow of loose powdered or granulor material in a larger product flow. Angled deflector surface 38 directs material into cell 31 so that bulking of the flowing material in the measuring cell 31 occurs. Constraining means such as an orifice 36 or the like may be included at the bottom of the measuring cell to assist in bulking the particulate solids. Energy from transmitter 32 is detected by detector 33.

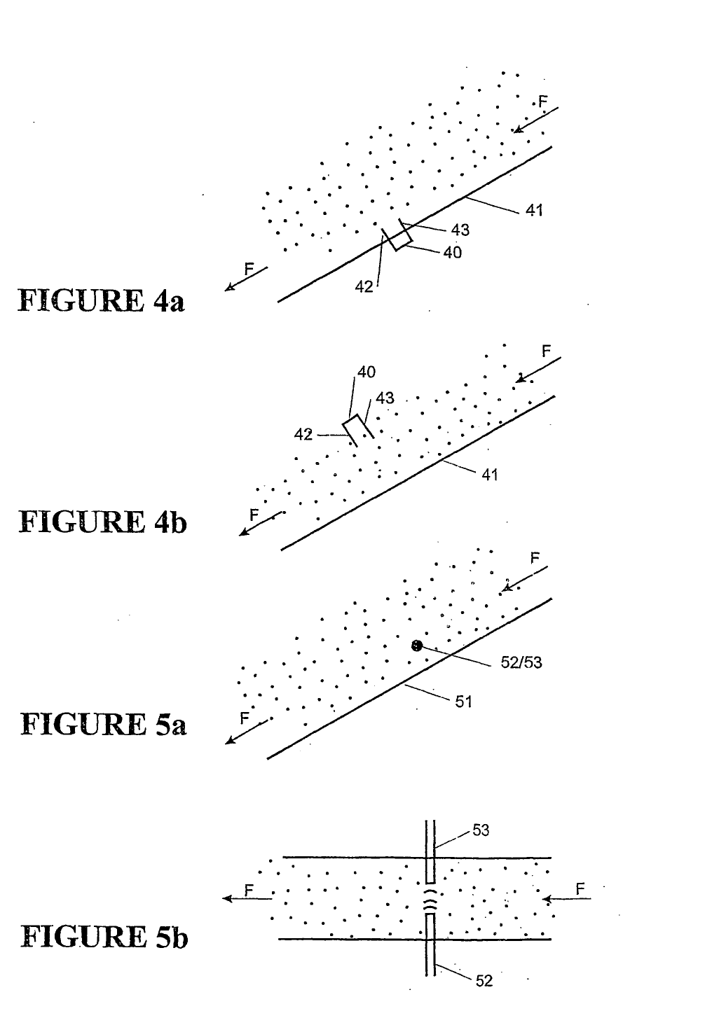

FIGS. 4A and 4B show an arrangement for determining particle size in material flowing down a descending surface 41, which may for example be a chute or similar. Transmitter 42 and detector 43 may be mounted in a common transmitter-detector head 40, with sound velocity or transmission time, and thus particle size, being determined from the time taken for energy to pass through the flowing material between the transmitter 42 and detector 43. FIG. 4B shows a similar arrangement where material flows down a surface 41 except that the transmitter-detector head is positioned above the material flow such that the transducer and detector prongs 42 and 43 are generally immersed in the depth of the material flow. Alternatively again a common transmitter-detector head could contact the material from a side of the material flow. The transmit and detect elements may be integrated in a common electronic component which could optionally supply data to a process control system over an rf or infra red link for example instead of a hard wire connection.

FIGS. 5A and 5B show another arrangement for assessing particle size in a product flow down a chute or other descending surface 51, in which energy is transmitted between a transmitter 51 which enters the product flow from one side of the chute and a detector 53 on the other side.

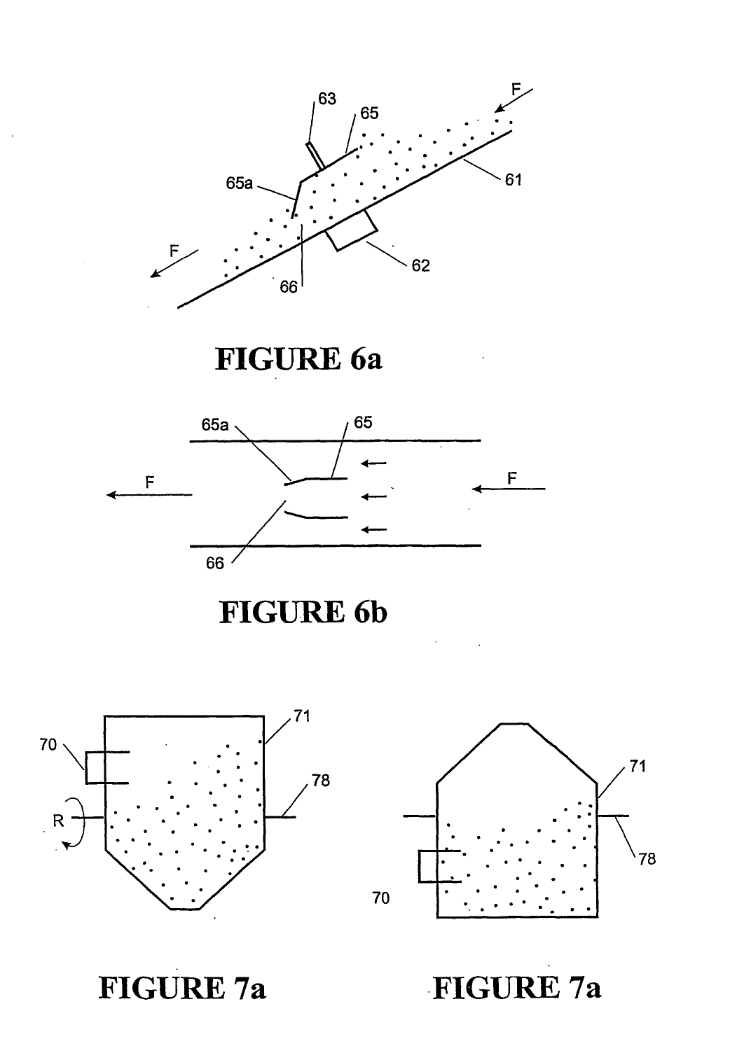

FIGS. 6A and 6B again show another arrangement for assessing particle size in a material flow down a descending surface such as a chute or within a descending conduit, or similar. Restrictor device 65 is provided within the product flow as shown to continuously delay and bulk a sample of some of the material flow. Angled surfaces 65a of the restrictor device 65 define an outlet 66 through which material continuously flows from the restrictor device 65. Transmitter 62 and detector 63 are provided above and below the restrictor device but may alternatively be provided on either side of the restrictor device.

FIGS. 7A and 7B show an arrangement which enables the assessment of particle size in a material moving in a mixer or bin blender or other rotating vessel. Bin blender 71 containing particulate material rotates about axis 78 as indicated by arrow R. A transmitter-detector head 70 is mounted in a side of bin 71. As the bin rotates the transmitter-detector head will be repeatedly immersed in the bulk material (FIG. 7B) and clear of the bulk material (FIG. 7A). The transmitting and detecting of the signal between the transmitter and detector may be synchronised with the rotational motion of the bin so as to occur during a part of each rotation of the bin when the transmitter-detector sensor head will be immersed in the particulate material within the bin. Alternatively the signal may be transmitted continuously and the time periods during which the transmitter-detector are in contact with the particulate material should be readily apparent in the received signal.

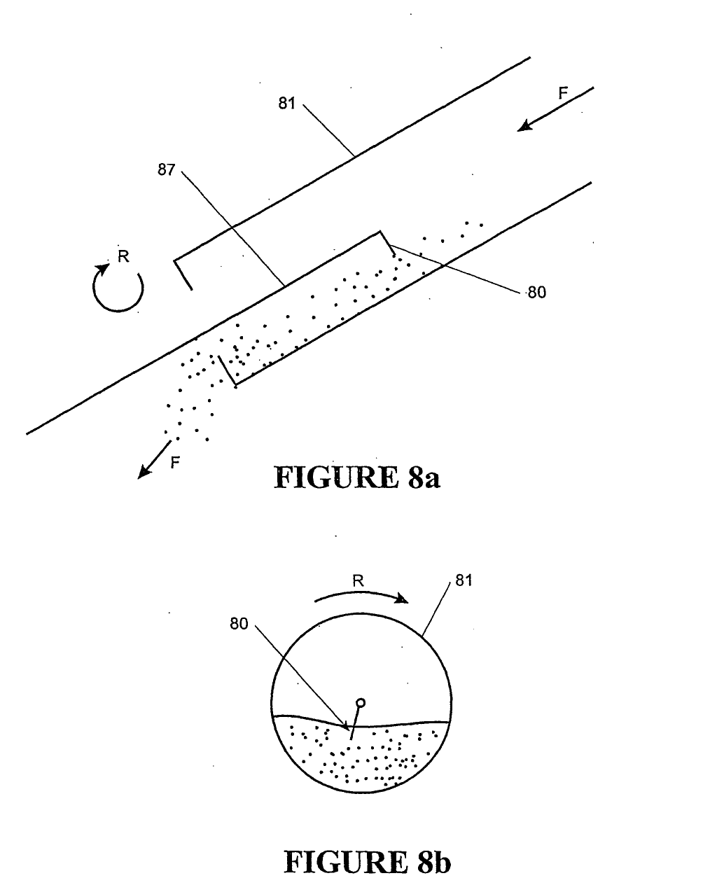

FIGS. 8A and 8B show an arrangement for assessing particle size of a batch of material in a drum granulator 81, or material continuously flowing through a drum granulator, which in use rotates about its longitudinal axis as indicated by arrow R. A transmitter-detector head 80 is supported by bar 87 so that the transmitter-detector head will be immersed in the material in the drum granulator as shown.

Tables 1A and 1B below show materials used in experimental work with the method of the invention. The materials listed in table 1A range in surface mean particle size from about 65 μm to 2000 μm; the materials listed in table 1B range up to about 6000 μm in mean particle size.

TABLE 1A

| | Minimum | Maximum | Surface Mean | Particle | Bulk |
|---|---|---|---|---|---|
| | Sieve Size | Sieve Size | Diameter | Density | Density |
| Material | (μm) | (μm) | (μm) | (kg m⁻³) | (kg m⁻³) |
| Glass Ballotini | 45 | 90 | (67.5) | 2450 to 2500 | 1429 |
| Glass Ballotini | 90 | 150 | (120) | 2450 to 2500 | 1408 |
| Glass Ballotini | 150 | 212 | (181) | 2450 to 2500 | 1462 |
| Glass Ballotini | 212 | 300 | (256) | 2450 to 2500 | 1456 |
| Sand | | | 132 | 2610 | ^{˜}1290 |
| Sand | | | 151 | 2610 | ^{˜}1290 |
| Sand | | | 160 | 2610 | ^{˜}1290 |
| Magnetite | | | 117 | 4266 | 2288 |
| Casein | | | 320 | | 515 |
| Alumina | | | 67 | 2810 | 1016 |
| Rape Seed | | | 2009 | | 598 |

TABLE 1B

| | | | Surface | Bulk |
|---|---|---|---|---|
| | | | Mean | Density |
| | Mean Minimum | Mean Maximum | Diameter | (kg |
| Material | Dimension (μm) | Dimension (μm) | (μm) | m⁻³) |
| Drummed | 3210 | 4270 | ^{˜}3700 | 586 |
| Plastic | | | | |
| Drummed | 2030 | 3460 | ^{˜}2745 | 597 |
| Plastic | | | | |
| Cut Rod- | 1690 | 3170 | 2810 | 689 |
| Plastic | (Diameter) | (Length) | | |
| Lupins | 5090 | 7170 | ^{˜}6130 | 804 |

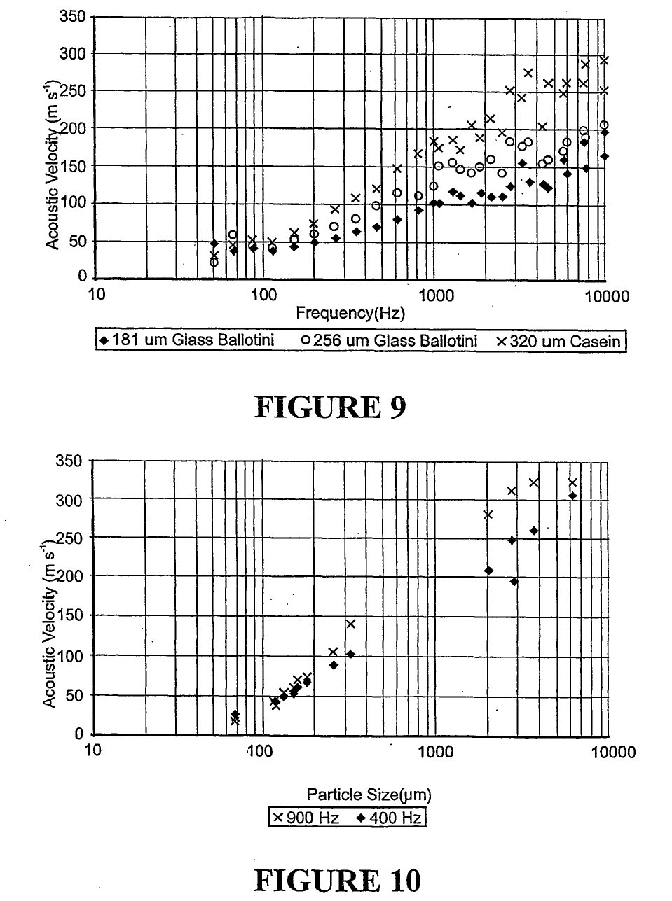

FIG. 9 shows the measured velocity against frequency for 1811 m mean diameter glass Ballotini, 256 μm mean diameter glass Ballotini and 320 μm mean diameter Casein. There is a range of frequencies over which the different sized materials are uniquely defined by the signal propagation velocity. In this case from about 200 Hz the signal velocity begins to differ significantly for the different sized materials.

FIG. 10 shows results of measurements through all of the materials at frequencies of 400 Hz and 900 Hz, plotted against the surface mean particle diameter. The measurements are the average of 20 measurements taken at 10 second intervals during flow. The relationship is generally consistent for all the materials, even though the particle densities vary significantly, indicating that the surface mean size gives a good measure of the effective mean size of the particles. The relationship with particle size in FIG. 10 shows a slightly stronger relationship between acoustic velocity and particle size for the small particles using the higher frequency. The higher frequency measurements however appear to have reached a limiting velocity for the larger particles of just in excess of 300 ms⁻¹ shown at points 6 and 7. Lower frequency measurements however will give a unique distinction between larger particles, as shown in FIG. 10 at points 8, 9 and 10.

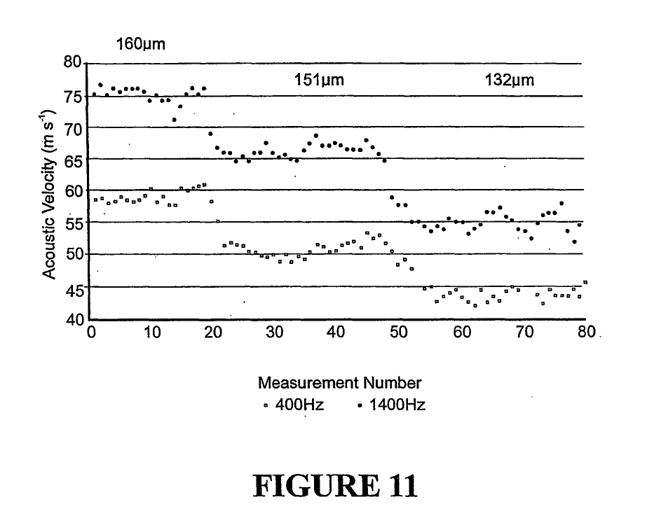

FIG. 11 shows velocity measured in flowing sand with transitions between three different mean surface particle sizes. To generate the graph of FIG. 11 a measurement column was filled with three successive layers of three size fractions of sand with surface mean diameters of 160 μm, 151 μm and 132 μm. Measurements for all of the materials show that there is a constant time delay between transmit and detect that is consistent over all of the materials, and so measurements of the velocity can be calculated from this and from a single time delay measurement at a fixed point inside the bed. Velocity measurements for FIG. 11 were recorded during the flow of the material containing the sequential layers of the three sand size fractions at frequencies of 400 Hz and 1400 Hz at approximately 10 second intervals. The measurements clearly show the transition between the different size fractions after approximately 20 measurements and 50 measurements. There is some variation between individual measurements within the same size fraction due to inherent in-homogeneities inevitably present in each of the material samples. The degree of variation suggests that the average differences in the mean particle size of less than about 2 μm (1.5%) can be resolved using this material and measurement layout.

Advantageously a particle size assessment stage of the invention may be combined with a bulk density assessment stage. It may be useful in a production situation to provide an indication of both the particle size and bulk density of material in a product flow. Bulk density variation may impact on the accuracy of the particle size assessment method of the invention and thus bulk density information may be added to the particle size assessment to improve the accuracy of the particle size assessment.

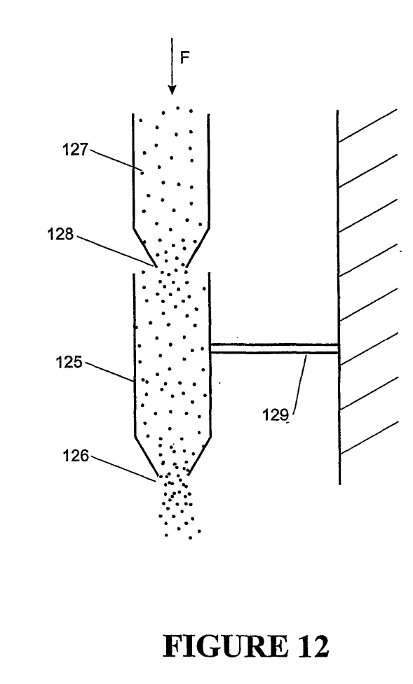

FIG. 12 shows one preferred form of bulk density measurement stage. Material in a product stream flows into weighing cell 125 which at its lower end comprises an outlet 126 of a restricted size relative to the weighing cell inlet. A feed cell 127 may be mounted above the weighing cell 125 as shown. The feed cell and weighing cell are typically positioned in the flowing product stream which fills the feed cell 127 with material which then flows into and through the weighing cell 125. It is most preferred that the spacing between weighing cell 125 and the feed cell 127 and the relative sizes of the outlet 126 of the weighing cell and the outlet 128 of the feed cell are such that the converging sides of the material at the top of the weighing cell meet the outlet 128 of the feed cell. The weighing cell will then continuously contain a constant volume of flowing material (without necessarily being full to overflowing) and material will flow from the feed cell into the weighing cell as fast as it flows from the weighing cell. In an alternative arrangement the outlet 128 of the feed cell could be significantly larger than the weighing cell outlet 126 and excess material will simply spill from the top of the weighing cell back into the product stream. The provision of a feed cell 127 or similar is preferred to ensure a regular flow into the weighing cell 125.

The weighing cell is suitably supported by means arranged to provide an indication of the weight thereof, which is schematically indicated by an arm 129 suitably connected to a load cell (load cell not separately shown in the drawing). Any suitable mechanical arrangement for supporting the weighing cell and any suitable arrangement of load cells, strain gauges, scales or the like which will determine the weight thereof may be employed. The load cell will provide a continuous weight indication of the contents of the weighing cell to for example a microprocessor programmed with a look up table for example, knowing the constant volume of material in the weighing cell and calculating the instantaneous bulk density of the contents of the weighing cell from the weight indication provided.

As stated the density information may be combined with the particle size information to improve the accuracy of the particle size assessment in a

computerised control system for process control. Transmitter 122 and detector 123 may be mounted in the weighing cell 125 (or feed cell 127) to provide the particle size information, rather than in a separate particle size measuring cell.

The foregoing describes the invention including a preferred form thereof. Alterations and modifications as will be obvious to those skilled in the art are intended to be incorporated within the scope hereof as defined in the accompanying claims.

1. A method for assessing the particle size of a bulk particulate material, including:
transmitting sound energy (as herein defined) through the particulate material from a source to a detector, and
assessing the particle size from the the time taken for said energy to pass through the material from the source to detector or signal velocity, through the material.

2. A method according to claim 1 wherein the sound energy is a frequency or frequencies in the range about 20 Hz to 20 k Hz.

3. A method according to claim 1 wherein the sound energy is a frequency or frequencies up to about to 10 k Hz.

4. A method according to any one of claims 1-3 wherein the mean diameter of the particles of the particulate material is less than about 6000 microns.

5. A method according to any one of claims 1-4 wherein the material is moving during transmission and detection of the sound energy.

6. A method according to claims wherein the moving material is material in a stream of flowing particulate material.

7. A method according to either one of claims 4 and 5 including causing the material to flow through a measuring cell positioned within the material flow and which tends to bulk the material and wherein the signal source and the detector are arranged to transmit and detect the sound energy through material in the measuring cell.

8. A method according to any one of claims 5 to 7 including carrying out the method continuously or semi-continuously to provide an on-line indication of particle size for moving particulate material.

9. A method according to either one of claims 7 and 8 including also assessing the bulk density of the material in the measuring cell.

10. A method according to claim 9 including combining information on the bulk density of the material with information on the particle size of the material to improve the accuracy of the assessment of particle size.

11. Apparatus for assessing the size of particles of a bulk particulate material including a signal source arranged to transmit sound energy (as herein defined) through the material, a detector arranged to detect the transmitted energy, and means arranged to assess particle size from the time taken for the signal to travel from the source to the detector or the signal velocity, through the material.

12. Apparatus according to claim 11 wherein the signal source is arranged to transmit sound energy having a frequency or frequencies in the range about 20 Hz to about 20 k Hz through the material.

13. Apparatus according to claim 11 wherein the signal source is arranged to transmit sound energy having a frequency or frequencies up to about 10 k Hz through the material.

14. Apparatus according to any one claims 11 to 13 including a measuring cell arranged to be positioned within the material flow and which tends to bulk the material and wherein the signal source and the detector are arranged to transmit and detect the sound energy through material in the measuring cell.

15. Apparatus according to claim 14 wherein the inlet to the measuring cell is larger than the outlet for flowing material from the measuring cell.

16. Apparatus according to claim 15 wherein the measuring cell or at least a lower part of the measuring cell has an inverted frustro-conical shape.

17. Apparatus according to claim 15 wherein the measuring cell is defined between two or more surfaces positioned within the material flow and which are angled towards each other in the direction of the material flow.

18. Apparatus according to any one of claims 11 to 17 wherein a surface larger in area than the entry to the measuring cell is associated with the measuring cell for catching and directing flowing material to the measuring cell and assisting in bulking material in the measuring cell.

19. Apparatus according to any one of claims 11 to 18 wherein the signal source and detector are associated with a sloping surface down which the flowing material is arranged to descend.

20. Apparatus according to claim 19 wherein the measuring cell is defined between a restrictor element and said sloping surface and wherein an entry to the measuring cell is defined between one end of the restrictor element and an upper part of the sloping surface and a smaller exit from the measuring cell is defined between another end of the restrictor element and a lower part of the sloping surface.

21. Apparatus according to any one of claims 11 to 18 wherein the signal source and detector are associated with a rotating vessel or device which is adapted to contain the particulate material or though which flowing material passes.

22. Apparatus according to claim 21 wherein the rotating vessel comprises a mixer or bin blender.

23. Apparatus according to claim 21 wherein the rotating device comprises a rotating granulator.

24. Apparatus according to any one of claims 11 to 23 wherein the signal source and detector are provided in a common transmitter-detector head.

25. Apparatus according to any one of claims 11 to 24 in combination with a density measurement stage for also assessing the bulk density of the particulate material.

26. Apparatus according to claim 25 including processing means arranged to combine information on the bulk density of the material with information on the particle size of the material to improve the accuracy of the assessment of particle size.

27. Apparatus according to claim 25 or claim 26 wherein the density measurement stage includes a weighing cell having an inlet through which the particulate material may flow into the weighing cell to maintain a constant volume of flowing material in the weighing cell and an outlet for exit of the flowing material from the weighing cell, means associated with the weighing cell for continuously or semi-continuously providing an indication of the weight of the contents of the cell, and means for continuously or semi-continuously determining the bulk density of the material passing through the weighing cell by reference to the weight indication thereof.

28. Apparatus according to claim 27 also including a feed cell which supplies flowing material to the weighing cell.

29. Apparatus according to claim 28 wherein the spacing between the weighing cell and the feed cell and the relative sizes of the outlet of the weighing cell and the outlet of the feed cell are such that in use the converging sides of a conical top of material in the weighing cell will meet the outlet of the feed cell.

30. Apparatus according to any one of claims 25 to 29 wherein the signal source and detector are associated with the weighing cell or feed cell and arranged to transmit sound energy through material in the weighing cell or feed cell for particle size assessment.
